(19) United States
(12) Patent Application Publication
(10) Pub. No.: US 2007/0250538 A1
(43) Pub. Date: Oct. 25, 2007

(54) SYSTEM AND METHOD FOR MONITORING AND DISPLAYING DATABASE PERFORMANCE INFORMATION

(75) Inventor: David Moore, Austin, TX (US)

Correspondence Address: DUBOIS, BRYANT, CAMPBELL & SCHWARTZ, LLP, 700 LAVACA STREET, SUITE 1300, AUSTIN, TX, 78701, US

(73) Assignee: Database Brothers, Inc., Austin, TX (US)

(21) Appl. No.: 11/733,983

(22) Filed: Apr. 11, 2007

Related U.S. Application Data
(60) Provisional application No. 60/794,009, filed on Apr. 21, 2006.

(51) Int. Cl. G06F 7/00

(52) U.S. Cl. 707/104.1

(57) ABSTRACT

A system and method for monitoring and displaying database parameters and performance metrics is provided. The database parameters and performance metrics are displayed on a streaming ticker. The streaming ticker indicates when the parameters and performance metrics change and when the parameters and performance metrics are out of specified ranges. The streaming ticker includes hyperlinks to allow a user to receive additional information.

### CROSS-REFERENCE TO RELATED APPLICATIONS

This non-provisional application claims priority based upon prior U.S. Provisional Patent Application Ser. No. 60/794009 filed Apr. 21, 2006 in the name of David Moore, entitled “Database Performance Information in a Scrolling Ticker Display,” the disclosure of which is incorporated herein by reference.

### BACKGROUND OF THE INVENTION

Embodiments of the present invention relate to monitoring database parameters and performance metrics and displaying the parameters and performance metrics on a streaming ticker.

Databases often contain a wealth of information. In many instances, the performance of a database is dependent on many factors such as its size and usage. It would be desirable to have a streaming ticker that displays database parameters and performance metrics for better managing database performance.

### BRIEF SUMMARY OF THE INVENTION

In the following discussion and in the claims, the terms “including” and “comprising” are used in an open-ended fashion, and thus should be interpreted to mean “including, but not limited to . . . .” Also, the term “streaming ticker” means any graphical display generated from a push broadcast over any medium, including for example a web page that acts like a ticker by being updated continuously or very frequently as new items enter the system. A streaming ticker may be located on a server or it may be on a client device. It is further noted that all functions described herein may be performed in either hardware or software, or a combination thereof, unless indicated otherwise. The present invention provides a system and method for monitoring a database for certain parameters. The parameters are collected and used to calculate performance metrics. The database parameters and performance metrics are then displayed on a streaming ticker. A user may also specify the parameters and performance metrics. The streaming ticker may indicate when the parameters and performance metrics change and when the parameters and performance metrics are out of specified ranges. The streaming ticker may also include hyperlinks to allow a user to receive additional information.

According to one aspect of the invention, a system for monitoring and displaying database parameters and performance metrics is provided comprising monitoring a database for certain parameters, collecting said parameters from said database, calculating performance metrics from said parameters, and displaying some or all of said parameters and said performance metrics on a streaming ticker.

### BRIEF DESCRIPTION OF THE DRAWINGS

For a detailed description of the various embodiments of the invention, reference will now be made to the accompanying drawings in which:

FIG. 1 is a flow chart showing the monitoring and display of the database parameters and performance metrics;

FIG. 2 is an example screen for allowing a user to specify parameters, performance metrics, and operating ranges;

FIG. 3 is an example screen for allowing a user to specify custom parameters, performance metrics, and operating ranges; and

FIG. 4 is an example screen showing additional information available by clicking on a hyperlink.

### DETAILED DESCRIPTION

Embodiments of systems and methods relating to the monitoring of database parameters and performance metrics and displaying the parameters and performance metrics on a streaming ticker are described in this detailed description of the invention. In this detailed description, for purposes of explanation, numerous specific details are set forth to provide a thorough understanding of embodiments of the present invention. One skilled in the art will appreciate, however, that embodirnents of tne present invention may be practiced without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of embodiments of the present invention.

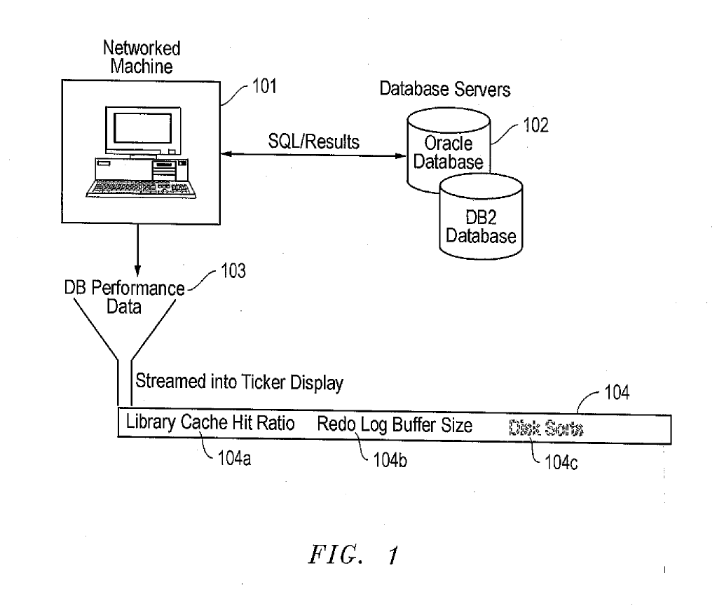

In accordance with an embodiment of the present invention shown in FIG. 1, a software application on a networked machine 101 routinely monitors certain database parameters of a database located on database servers 102. Examples of databases are DB2 and Oracle. The database software application systematicaly collects the database parameters. After collection, the software calculates certain performance metrics 103. The database parameters and performance metrics are displayed on a streaming ticker 104. The streaming ticker uses different speeds, colors, and symbols in displaying information in order to inform a user when the database parameters or performance metrics change or when they are outside of certain operating ranges. For example, the display in FIG. 1 shows “# Blocking Sessions” in red 104a to indicate that this parameter is outside of its ideal operating range. Also, a blue arrow follows the parameter “Redo Log Buffer Size” 104b to indicate that this parameter is increasing. The parameter “% Disk Sorts” 104c is displayed in yellow to warn that this parameter is close to being outside of its operating range. In addition, a hyperlink is included in the parameter “% Disk Sorts” 104c to inform the user that additional information is available concerning this parameter. Hyperlinks are provided for all monitored parameters. The time delay between the time the collection of the database information and the display of that information is minimized so that the user receives timely updates on the databases performance. Tne streaming ticker can also be displayed on a computer monitor to allow a user to easily monitor databases while performing other tasks on the computer.

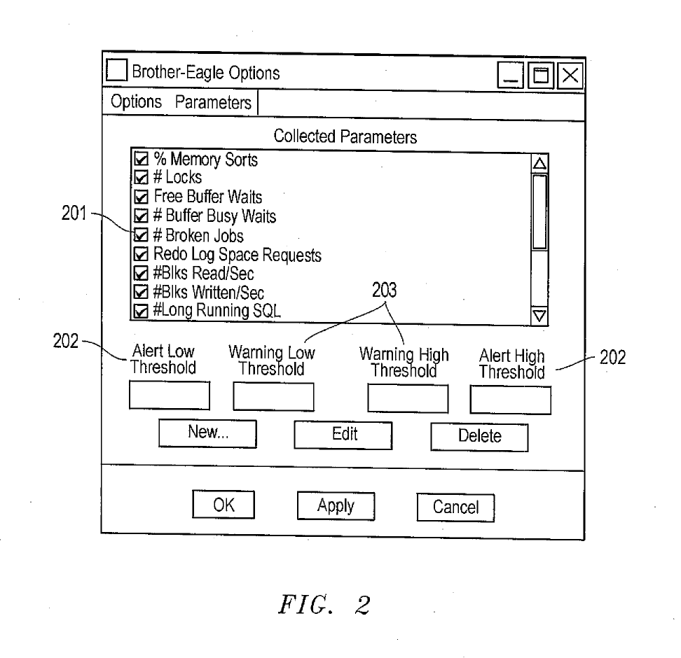

As shown in FIG. 2, a user can specify the parameters and performance metrics that the user desires to see on the streaming ticker by checking option boxes 201. A user can also specify warning thresholds 203 and alert thresholds 202 so that the display acts as an alarm system, informing the user when the thresholds are close to being exceeded or have been exceeded. If a user does not care about certain parameters or performance metrics, the user can just elect to not check those parameters or performance metrics and they will not be collected or displayed on the streaming ticker.

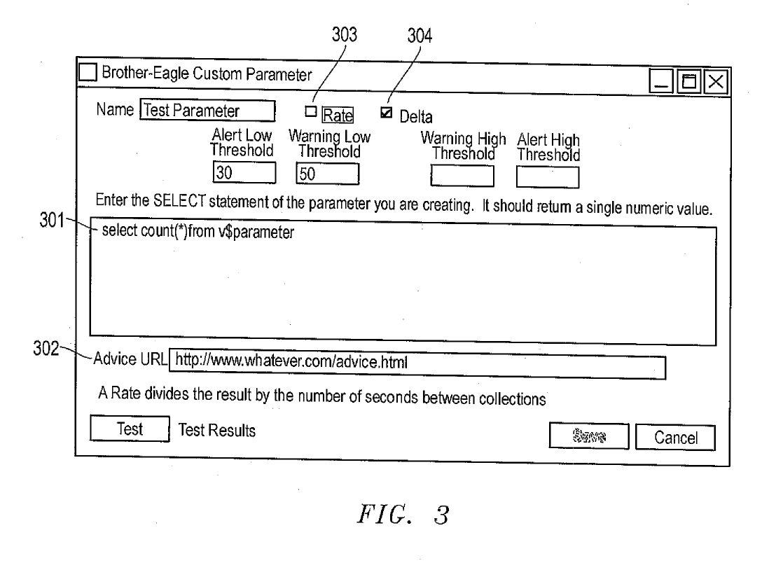

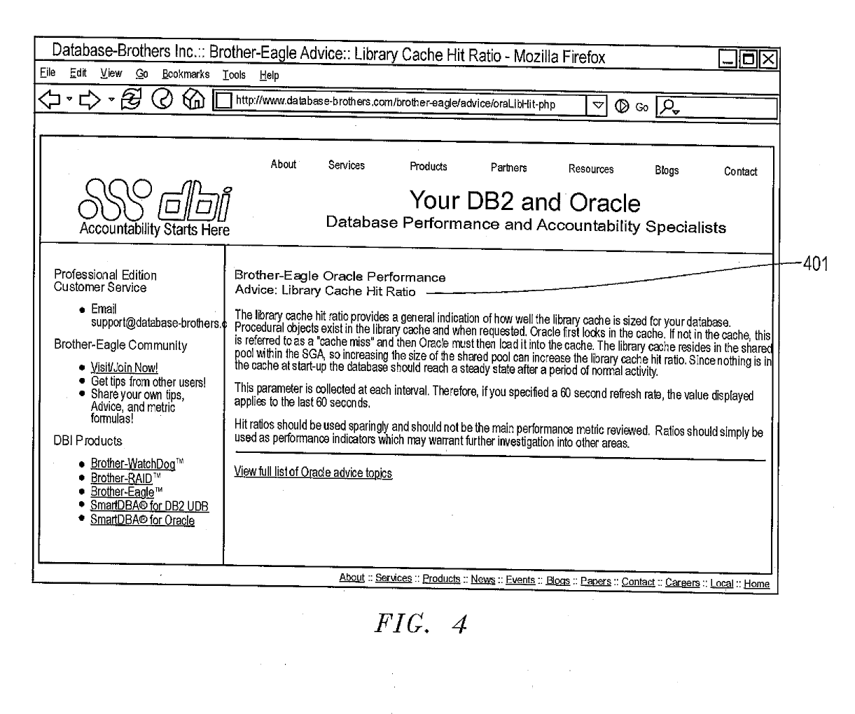

As shown in FIG. 3, a user can also create custom parameters and performance metrics that the user desires to see on the streaming ticker 301. A user can also specify the rate 303, changes 304, color, symbols, and hyperlinks that are used in connection with the display of information on the streaming ticker. In addition, a user can specify a uniform resource locator 302 for the location of additional information relating to the displayed information. For example, as shown in FIG. 4, such additional information might include advice or background information relating to a performance metric such as “Library Cache Hit Ratio” 401. The specified uniform resource locator may point to expert advice on the user's own internal website or to a website available through the internet.

While the present invention has been disclosed according to the preferred embodiment, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of possible streaming tickers, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1. A system for monitoring and displaying database parameters and performance metrics comprising:
monitoring a database for certain parameters;
collecting said parameters from said database;
calculating performance metrics from said parameters; and
displaying some or all of said parameters and said performance metrics on a streaming ticker.

2. The system of claim 1 further comprising allowing a user to specify one or more of said parameters and said performance metrics.

3. The system of claim 1 further comprising allowing a user to specify operating ranges for one or more of said parameters and performance metrics.

4. The system of claim 3 in which said streaming ticker indicates when said parameters and said performance metrics are outside of said specified operating ranges.

5. The system of claim 1 in which said streaming ticker indicates when said parameters and said performance metrics have changed.

6. The system of claim 1 in which said streaming ticker is displayed on a computer monitor.

7. The system of claim 1 further comprising a means for a user to receive additional information regarding one or more of said parameters and said performance metrics wherein said streaming ticker includes a hyperlink for each said parameter and said performance metric and said user can click on said hyperlinks to receive additional information.

8. A method for monitoring and displaying database parameters and performance metrics comprising:
monitoring a database for certain parameters;
collecting said parameters from said database;
calculating performance metrics from said parameters; and
displaying some or all of said parameters and said performance metrics on a streaming ticker.

9. The method of claim 8 wherein a user is specifies one or more of said parameters and said performance metrics.

10. The method of claim 8 wherein a user specifies operating ranges for one or more of said parameters and performance metrics.

11. The method of claim 10 in which said streaming ticker indicates when said parameters and said performance metrics are outside of said specified operating ranges.

12. The method of claim 8 in which said streaming ticker indicates when said parameters and said performance metrics have changed.

13. The method of claim 8 in which said streaming ticker is displayed on a computer monitor.

14. The method of claim 8 in which said streaming ticker includes a hyperlink for each said parameter and said performance metric and said user can click on said hyperlinks to receive additional information.
